(19) United States
(12) Patent Application Publication
(10) Pub. No.: US 2004/0233045 A1
(43) Pub. Date: Nov. 25, 2004

(54) Automated vehicle information system

(76) Inventor: Wesley M. Mays, Coppell, TX (US)

Correspondence Address: BLANK ROME LLP, 600 NEW HAMPSHIRE AVENUE, N.W., WASHINGTON, DC, 20037, US

(21) Appl. No.: 10/795,993

(22) Filed: Mar. 10, 2004

Related U.S. Application Data
(60) Provisional application No. 60/452,963, filed on Mar. 10, 2003.

(51) Int. Cl. B60Q 1/00

(52) U.S. Cl. 340/425.5; 340/901

(57) ABSTRACT

An automated vehicular information retrieval and delivery system is disclosed. The system integrates, into a single module, a plethora of discrete information and data related to vehicular operating status and a surrounding highway infrastructure. Integrated information is accessible to occupants of a vehicle, an on-board computer in the vehicle, and to the surrounding infrastructure. The data and information is routed throughout the system via a communications medium. The communications medium may be hard-wired and a wireless technology.

### REFERENCE TO RELATED APPLICATION

This application claims priority to copending U.S. provisional application 60/452,963, filed Mar. 10, 2003, which is entirely incorporated herein by reference.

### FIELD OF THE INVENTION

The present invention relates to vehicle information retrieval and delivery systems, and more particularly, to an integrated information system that provides a plethora of information and data to a vehicle driver and its occupants, to the on-board computer within the vehicle, and to the highway infrastructure.

### BACKGROUND OF THE INVENTION

It is well known in the art to include information retrieval systems in a motor vehicle in order to provide the driver with information and/or data regarding the current operating status of the vehicle. Such information retrieval systems include speedometers, odometers, fuel, temperature and oil pressure gages, to name a few examples. In most older vehicles, these information retrieval systems operate independently in that they present information to the driver without coordination. More recently, the motor vehicle industry has produced vehicles having somewhat more sophisticated information retrieval systems in which data collected from various sources is correlated together and used for control of certain vehicle functions, e.g. fuel consumption, transmission control, shock absorption, etc. An example of a vehicle information collection and control system is provided by U.S. Pat. No. 4,760,275 for “Communication System For Vehicle.” The '275 patent discloses a vehicle system having a plurality of sensors that communicate with a processor used to control various other vehicle functions. Notably, the sensors disclosed in the '275 patent only collect information regarding the vehicle operation, and do not collect any information regarding conditions external to the vehicle, e.g., traffic conditions. Moreover, the collected information is not presented to the driver of the vehicle, but is only used for vehicle control.

Other vehicle information systems collect discrete types of external data and present that information to the driver. For example, U.S. Pat. No. 4,747,064 for “Approaching Vehicle Informing System and Method,” discloses a system that warns a driver of the presence of an approaching emergency vehicle. The system provides the driver with information regarding the amount of time until the vehicles meet. Also, U.S. Pat. No. 5,699,056 for “Traffic Information System,” discloses a system that collects traffic information such as traffic jam information, accident information and weather information. The system includes a car navigation system that senses vehicle position, a laser radar that detects vehicle numbers, speeds, and shapes, and a manual entry system for entering certain additional information. The collected information is communicated to a center that processes the data and returns the processed data back to the vehicle.

More recently, advancements in telecommunications and computer processing power have driven a demand for more advanced vehicle information systems. With changing regulations from the Federal Communications Commission, and with funding from the Federal Highway Administration, various organizations are advocating the development of advanced traffic control systems. So-called Intelligent Transportation Systems (ITS) apply emerging hard and soft information systems technologies to address and alleviate transportation congestion problems. For example, using advanced surveillance systems, the early stages of a traffic bottleneck situation can be detected, and traffic can then be directed to other routes to mitigate the congestion and to provide faster and more efficient routes for travelers. New technologies enable this type of surveillance and guidance response to occur in real time, and therefore, to allow potential congestion situations to be addressed before they develop into serious traffic jams. Multiple other benefits can also be realized from ITS, including driver safety, pollution reduction, theft deterrence, vehicle location, route planning, driver information, hazard detection, collision avoidance, emergency vehicle preemption, and driver assistance.

The proposed ITS systems comprise “add-on” features to existing vehicle designs, in which a number of different sensors, communication links, and display devices are interconnected in a somewhat random fashion to provide the desired functionality. As a result, these systems are not commercially viable due to the high component cost and the associated installation cost. FIG. 1 depicts a vehicle having a plurality of discrete, stand-alone systems. It would therefore be more desirable and commercially viable to integrate those discrete systems into a single module that communicates directly with the vehicle data bus.

Some manufacturers have already begun migrating driver assistance products into an integrated suite of services. The Cadillac division of General Motors Corp. offers a driver assistance package that combines advanced technology and customer service to provide motorists with safety, security and convenience. That system, known as OnStar, provides mobile communications service through the use of Global Positioning System (GPS) satellite technology and a voice-activated cellular phone to link the driver and the vehicle with the OnStar Center for real-time, person-to-person assistance. The OnStar system includes emergency services notification at the push of a button, automatic notification of emergency services if an air bag deployment is detected, theft-detection/notification and stolen vehicle tracking, remote door unlocking, and roadside assistance.

Other vendors have offered “stand-alone” systems intended for the vehicle after market. One such company, ATX Technologies, Inc., offers a personal security and asset protection solution for vehicles referred to as the On-Guard Tracking System. The On-Guard system uses the GPS satellite technology and cellular communications for a variety of applications, including theft protection and personal security, vehicle location determination, monitoring events within the vehicle, two-way voice communication with vehicle occupants, dispatch and guide emergency assistance to the vehicle, directional assistance by a trained communication specialist, and monitor and/or control select vehicle functions.

Notwithstanding the advantages of these stand-alone systems, it would be desirable to further integrate the traffic control systems, driver assistance systems and other security systems with the vehicle data bus to thereby expand the type and quality of information that can be provided to the driver.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective drawing of current technologies available for discrete vehicular, stand-alone information systems;

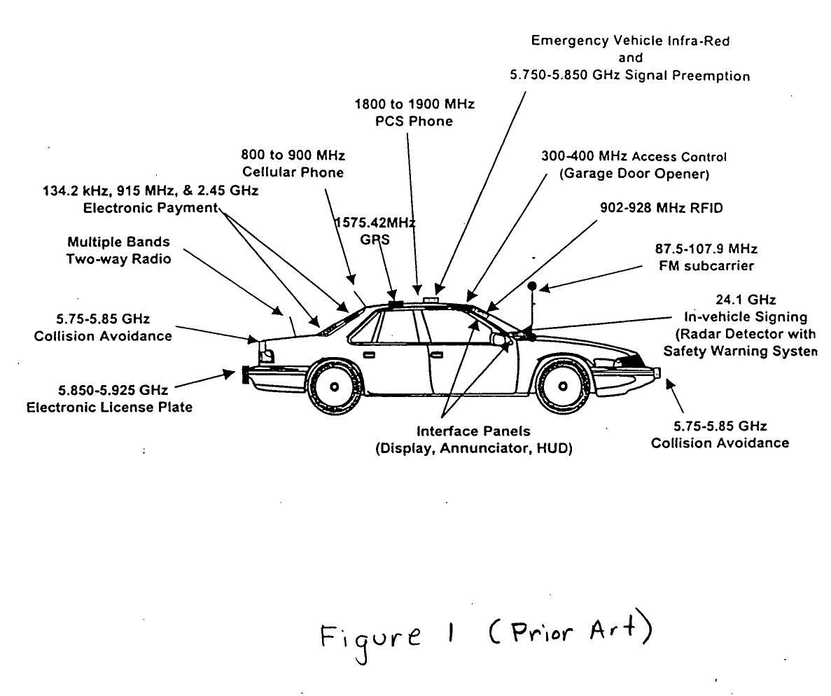

FIG. 2 is a perspective drawing indicating an embodiment of the present invention;

FIG. 3 is a block diagram of an embodiment of the integrated systems associated with FIG. 2; and

FIG. 4 is a block diagram of an embodiment of the integrated systems associated with FIG. 2.

### DETAILED DESCRIPTION OF THE PREFERRED EMBODIMENT

The present invention provides automatic two-way data transfer from multiple sources to allow a vehicle to be connected to an “information superhighway” infrastructure. The system provides real-time or near real-time information between the vehicle and the infrastructure. The data can be processed by both the infrastructure and vehicle to provide information to both parties. The highway infrastructure can use data from the vehicle to assess a variety of highway characteristics. The vehicle may elect to act on the information, and the infrastructure may pass certain data on to other vehicles depending upon the type of data collected.

The system incorporates certain existing technologies developed for single or independent use, including cellular telephone networks, the GPS satellite network, and radio frequency identification (RFID) systems for automatic toll collection, debit cards, service station payment, and traffic condition monitoring. The integration of those technologies provides the driver with advanced capabilities to navigate safely, provide security and protection, enhance highway worker safety, decrease commuting time, allow efficient use of highways, and decrease fuel consumption and air pollution. Those technologies are further integrated with vehicle sensors and other data sources that communicate with the vehicle data bus and processing system.

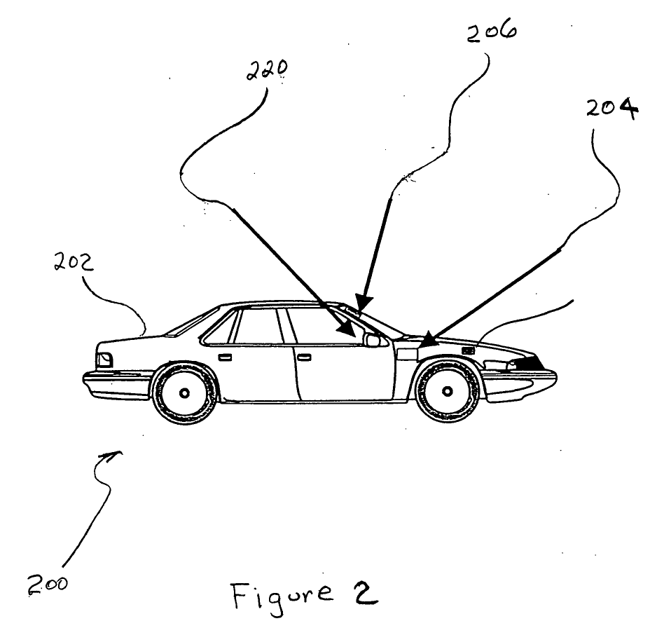

As shown in FIG. 2, an integrated vehicle information communication system 200 includes a dashboard display 220, an antenna 206, and a sub-processor module 204. Included in the sub-processor module 204 is a subprocessor 205 that processes information and data received within the integrated vehicle information communication system 200. The integrated vehicle information communication system 200 further includes a broadcast radio receiver (not shown), an interface to the vehicle on-board processor (not shown), and an interface to the vehicle messaging system (not shown). The existing vehicle messaging system could be augmented with additional user interface modules to alert the driver to special conditions or alerts. Data input may be provided by RFID tag using backscatter modulation, a radar warning receiver, a proximity detector, a vehicle status transmitter an engine status monitor, a tire condition monitor, a traction monitor, a road condition monitor, a speed sensor, an identification database, a payment database, a cellular telephone and a GPS receiver.

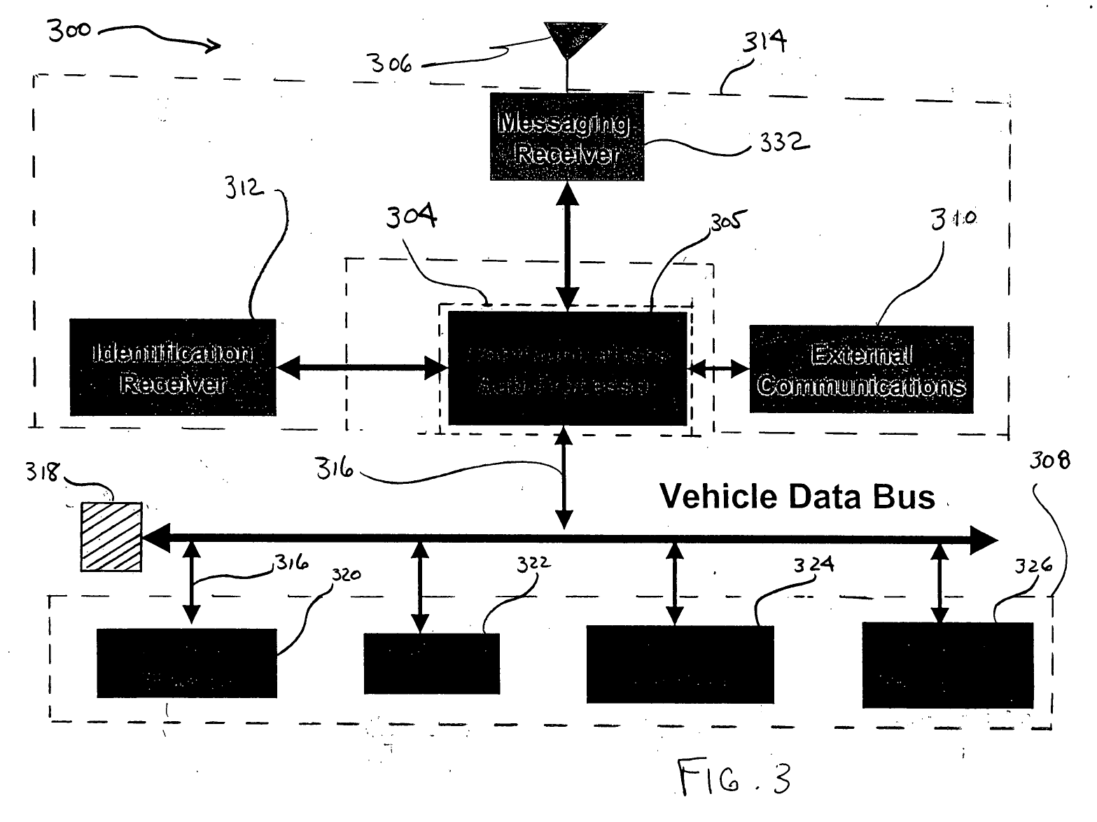

FIG. 3 illustrates a preferred embodiment of the integrated vehicle information communication system 300. The integrated vehicle information communication system 300 includes a sub-processor module 304 that includes a communications sub-processor 305 that processes communications signals received from external 314 and internal 318 sources via an antenna 306 over a communications medium 316, including a messaging receiver 332, an identification receiver 312 and an external communications circuit 310. The messaging receiver 332 receives messages from external computer systems, such as information broadcasts from government agencies. The identification receiver 312 receives RFID interrogation signals. The external communications receiver 310 receives voice and data signals communicated over commercial cellular phone networks. The communications sub-processor 304 processes each of these types of signals and communicates with the vehicle data bus via the communications medium 316. The communications sub-processor 305 also communicates with internal sources 318 and other vehicle systems, such as the vehicle engine control processor (not shown), through the vehicle data bus.

The integrated vehicle information communication system 300 further includes various user interface modules 308 for interfacing with the vehicle occupants, including a dashboard display 320, a heads up display 322, an audio interface 324 and a speech recognition system 326. A dashboard display 320 comprises a video screen, such as a liquid crystal display. The heads-up display 322 comprises a projecting system that forms images on the vehicle windshield. The audio interface 324 includes a speaker and microphone. The speech recognition system 326 converts audible commands into data signals that may be understood by the communications sub-processor 304. These user interface modules 308 enable external communications to be conveyed to the driver or other passengers. Moreover, those communications occur in a hands-free manner so as to not impede or distract the driver.

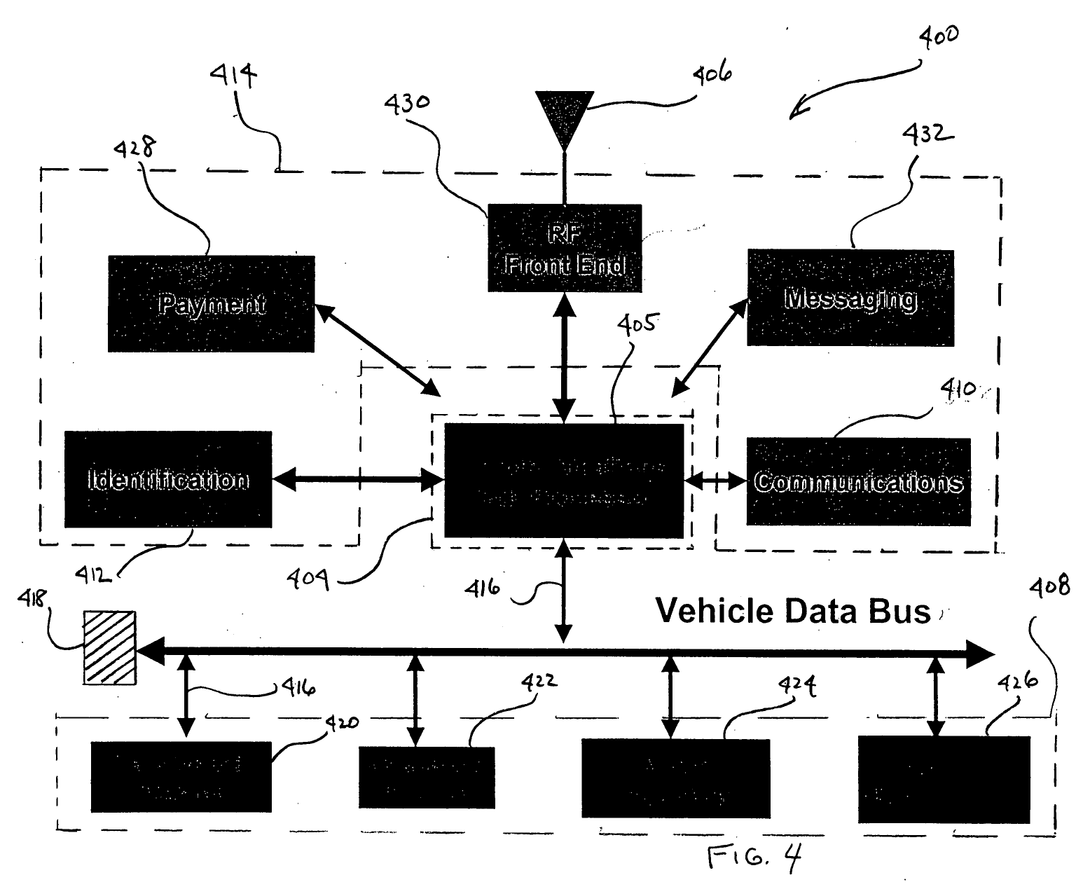

FIG. 4 illustrates a second embodiment of the integrated vehicle information communication system 400. As in the first embodiment, the integrated vehicle information communication system 400 includes a sub-processor module 404 that includes a communications sub-processor 405 that processes communications signals received from external 414 and internal 418 sources via various other systems. The second embodiment includes a greater number of separate systems that communicate with the communications sub-processor 405, including the identification system 412, a payment system 428, an RF front end 430, a messaging system 432, and a communications system 410. The messaging system 432 receives messages from external computer systems. The identification system 412 receives RFID interrogation signals. The communications system 410 receives voice and data signals communicated over commercial cellular phone networks. The payment system 428 manages certain financial accounts to manage payment of tolls, gasoline purchases, and other expenses. The RF front end 430 processes incoming/outgoing RF signals, and is further coupled to an antenna 406. The communications medium 416 used within the integrated vehicle information communication system 400 can be a wireless technolgy attributed to radio frequency (RF) technology, Bluetooth technology, or hard-wired.

The integrated vehicle information communication system 400 could be adapted to receive information broadcasts, such as from government agencies including the Federal Highway Administration and the state and federal Department of Transportation. Those broadcasts may be short range, such as warning of approaching highway work areas or emergency vehicle traffic. Longer range broadcasts could be devised to announce traffic slow-downs or traffic jams, and/or to suggest alternate routes during rush hour traffic conditions. Wide area announcements could warn of special weather conditions, notify vehicles of special driving conditions or post regulatory notices, speed monitoring, traffic advisories, traffic jam alerts, work area warnings, emergency vehicles notification, weather reports, hazardous conditions, and signal preemption. Law enforcement organizations can also communicate with the system to access vehicle identification information theft recovery and traffic violation monitoring purposes. To simplify the vehicle registration process, the license plate and registration could be correlated into an identification code that is transmitted upon query by an authorized agency. The present system can therefore be used for speed monitoring, emission control, and traffic citation purposes.

An important advantage of the system is the enhancement of safety to the vehicle and occupants, adjacent vehicles, and surrounding entities. Safety information that can be communicated may include highway/railroad intersection warnings, rollover warnings, rail engine to grade crossings, emergency vehicle signal preemption, transit vehicle signal priority, railroad warning, work area warning, weather reporting, radar warning, collision avoidance, hazard detection and information, safe driving distance warning, and speed control and monitoring.

The integration of personal communication systems, i.e., cellular telephone networks, into the present system permits long range communication, including the following services; telecommunications, including voice and data; remote vehicle location; route planning; vehicle status and monitoring; and theft detection and prevention. The system interconnection to both external 414 and internal 418 sources of data enables the supply of a variety of data to the driver. Depending on the data sources, the information can be prioritized by category (e.g., safety, vehicle operations, collision, etc.) The information can be displayed in a number of ways dependent upon the data, including traffic information and advisory notices, in-vehicle signing, road construction information, global positioning systems, advised routes, route information, address location and route planning.

The integrated vehicle information communication system 400 can be further adapted to provide payment services. Currently, RFID tags are used to, automatically collect toll revenue, and the service station industry has begun using RFID systems instead of credit cards for payment. Smart cards are expected to replace cash, checks and credit cards. The system can thereby communicate with existing RFID reading systems to communicate payment information for such applications as toll collection, fuel payment, retail payment, and drive-through retail payment.

Commercial users continue to need various applications that are not manageable by conventional technologies or techniques. These applications are historically independent point designs. In an embodiment of the invention, these applications are integrated into the system to provide functions such as driver's daily log, vehicle safety inspection record, tractor to trailer data transfer, transit vehicle data transfer, railroad database transfer, rail engine fueling control, mainline screening, international border clearance, vehicle and cargo tracking, on-board safety data, and unique commercial vehicle operations (CVO) fleet management.

Existing services have already capitalized on single point design as described above with respect to payment services. In free market economies, those areas of technology that are capable of generating revenue are the first areas to be developed. The identification marked is similar to the payment services application in that many transactions are on a per transaction cost basis. Furthering this line of development, systems have been implemented for years to provide a vast array of services based upon positive proof of identification. Private parking lots, apartments, commercial garages, exclusive housing communities, and airports have all benefited from providing services based on identification of a vehicle entering or leaving a premise. The present invention takes that concept further by providing an integrated identification system that provides applications such as access control, parking, electronic license plate, electronic vehicle registration, security and video enforcement.

Lastly, the invention enables a multitude of less commercially feasible techniques to be implemented simply for user convenience. The cost of implementing such techniques individually would be prohibitive, but could be included as part of an integrated system. These convenience applications would include vehicle repair service record tracking, rental car processing and tracking, and probe data collection.

Having thus described a preferred embodiment of an integrated vehicle information communication system, it should be apparent to those skilled in the art that certain advantages of the system have been achieved. It should also be appreciated that various modifications, adaptations, and alternative embodiments thereof may be made within the scope and spirit of the present invention.

What is claimed is:

1. An integrated vehicle information communication system that provides both vehicular and highway infrastructure information to both vehicle occupants, and a surrounding highway infrastructure, comprising:
an antenna for receiving and transmitting data from internal and external sources;
a sub-processor module for processing the data from the antenna and conveying the data to further processing;
a user interface system for interfacing the data received from the sub-processor module with the vehicle occupants; and
a communications medium for conveying data throughout the system.

2. The system according to claim 1, wherein the antenna is located in the windshield of the vehicle.

3. The system according to claim 1, wherein the sub-processor module includes a communications sub-processor for processing the data from the antenna and integrating with a vehicle bus.

4. The system according to claim 1, wherein the external sources include at least one of a messaging module, an identification receiver module, an external communications module, a payment module, and a radio frequency front end module.

5. The system according to claim 1, wherein the user interface system includes at least one of a dashboard display module, a heads-up display module, a speech recognition system module, and an audio interface module.

6. The system according to claim 1, wherein the communications medium includes a wireless technology.

7. The system according to claim 6, wherein the wireless technology includes radio frequency technology.

8. The system according to claim 6, wherein the wireless technology includes Bluetooth technology.

9. The system according to claim 1, wherein the communications medium is hard-wired.

10. A method for providing two-way communications of highway infrastructure and vehicular status information between occupants of a vehicle and a highway infrastructure, said method comprising:
providing an antenna on a vehicle;
receiving data from external sources in the highway infrastructure;
transmitting the data to a communications sub-processor for internal processing;
processing the data using the communications sub-processor and conveying processed data to a vehicle data bus; and
communicating the processed data along the vehicle data bus via a wireless communications medium to a user interface system.

11. The method of claim 10, further comprising receiving data from internal sources.

12. The method of claim 10, further comprising transmitting the processed data to the highway infrastructure.

13. The method of claim 10, wherein the wireless communications medium includes radio frequency technology.

14. The method of claim 10, wherein the wireless communications medium includes Bluetooth technology.

15. The method of claim 10, further comprising conveying the processed data to a vehicle engine control processor.

16. The method of claim 10, wherein the user interface system includes at least one of a dashboard display module, a heads-up display module, a speech recognition system module, and an audio interface module.
